(19) United States
(12) Patent Application Publication
(10) Pub. No.: US 2006/0001880 A1
(43) Pub. Date: Jan. 5, 2006

(54) Device and method for inspecting material

(76) Inventor: Bernd Rudiger Stober, Rheda-Wiedenbruck (DE)

Correspondence Address: Douglas R Hanscom;Jones Tullar & Cooper, P O Box 2266 Eads Station, Arlington, VA, 22202, US

(21) Appl. No.: 10/521,763

(22) PCT Filed: Jul. 22, 2003
(86) PCT No.: PCT/DE03/02466

§ 371 Date: Jan. 21, 2005

(30) Foreign Application Priority Data
Jul. 26, 2002 (DE) 102 34 084.6

(51) Int. Cl. G01J 3/50

(52) U.S. Cl. 356/406

(57) ABSTRACT

Material is inspected using a device that includes a sensor and an illumination unit. A test light is emitted by the illumination unit and is received by the sensor unit after reflecting off or shining through the material. This received light is evaluated in an evaluation unit. The illumination unit is provided with at least two light sources that emit test lights each having a different color. The sensor unit is provided with at least two color channels that are adapted to the different test lights of the light source.

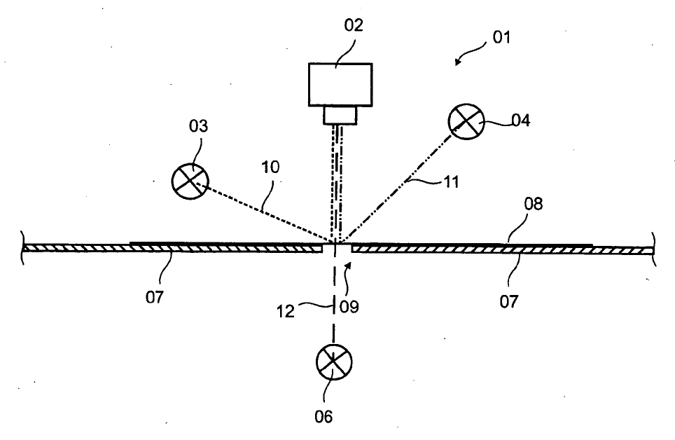

### CROSS-REFERENCE TO RELATED APPLICATIONS

This patent application is the U.S. national phase, under 35 USC 371, of PCT/DE2003/002466, filed Jul. 22, 2003; published as WO 2004/017266 A1 on Feb. 26, 2004 and claiming priority to DE 102 34 084.6, filed Jul. 26, 2002, the disclosures of which are expressly incorporated herein by reference.

### FIELD OF THE INVENTION

The present invention is directed to an arrangement and to a method for inspecting material. A sensor device received light from an illumination device that includes several light sources that emit inspection light.

### BACKGROUND OF THE INVENTION

Material inspecting arrangements are used, although not exclusively, for inspecting printed sheets which have been imprinted with, for example, securities. In this connection, the sheet-shaped material is illuminated by the use of an inspection light emanating from an illuminating device, and wherein the inspection light is either reflected at the surface of the material, in so-called incident light inspections, or shines through the material, in so-called transmitted light inspections. The inspection light is subsequently recorded by a sensor device, such as, for example, a camera, and the input signals detected in the course of this inspection are evaluated in an evaluating unit.

An arrangement for use in inspecting sheet-shaped material is known from WO 01/85586 A1. Two illuminating devices and two sensor devices are provided in this prior arrangement, which devices are respectively assigned to each other. The first illuminating device is arranged, with respect to its assigned sensor device, in such a way that the inspection light falls through the sheet-shaped material, so that a transmitted light inspection is made possible. The second illuminating device is arranged, with respect to its assigned sensor device, in such a way that the inspection light from the second illuminating device is reflected by the material, so that an incident light inspection is made possible. As a result, it is therefore possible to perform both an incident light inspection and a transmitted light inspection of the material to be inspected.

DE 44 34 168 A1, EP 0 952 438 A2, JP 10-185 690 A and U.S. Pat. No. 3,120,782 all disclose arrangements for use in inspecting material by the provision of a sensor device and of several light sources. The light sources each respectively emit an inspection light of a different color of the light.

GB 2 002 923 A and DE 15 12 179 B1 both show arrangements of light sources for the provision of incident light and of transmitted light.

### SUMMARY OF THE INVENTION

The object of the present invention is directed to on providing an arrangement and a method for inspecting material.

In accordance with the present invention, the object is attained by the provision of an arrangement for inspecting materials that includes a sensor device and an illumination device. Inspection light is emitted from the illumination device from several lights sources, is received by the sensor device, and is evaluated in an evaluation device. The illumination device has at least two light sources that each emits an inspection light which is colored differently from the light from other ones of the illumination device. The sensor has at least two color channels that are matched to the different inspection lights. Both incident light inspections and transmitted light inspections can be accomplished separately, yet at the same time.

A particular advantage of the present invention lies in that only one sensor device, such as, for example a color camera, a color line camera or a CCD camera, is required for being able to check various testing criteria by use of the subject arrangement. In this case, the present invention rests on the basic idea that the different testing criteria are checked by the use of light of different colors. Therefore, the illumination device has at least two light sources, each of which emits an inspection light of a different light color, i.e. of a different wave length. At least two different color channels are provided in the sensor device. It is possible by the provision of this arrangement to record lights of different colors using the sensor device, which different colored lights can then be separately evaluated in the evaluation unit. The input signals recorded by the sensor device can each be processed separately from each other in accordance with the respective color of light by use of the different color channels in the sensor device so that, while using only one sensor device, the different testing criteria are not mixed up.

It is particularly advantageous, in accordance with the present invention, if the light sources each emit an inspection light of a substantially monochrome light color. These monochrome light colors can be assigned, in a simple way, to the different color channels of the sensor device. The result is that an unintentional distortion or influencing of the input signals, in the different color channels, is essentially prevented.

The spectral position and/or the band width of the inspection light emitted by the light sources is matched to the transmission curve of the sensor device.

Commercially available color cameras, which can be used as sensor devices in the arrangement in accordance with the present invention, customarily have three separate color channels for the colors red, blue and green. It is therefore particularly advantageous for the illuminating device to have three light sources, whose inspection lights are matched to the respective properties of the three color channels. Three light sources, with the three monochrome light colors red, blue and green, for example, can be used for this purpose.

The arrangement of the present invention offers particular advantages if the light sources are arranged in different positions relative to the material that is to be inspected. As a result, it is possible to check different testing criteria by this arrangement of the lights sources in different positions, which correspond to the respective desired positions, while only a single sensor device must be provided.

In order to be able to adapt the arrangement of the present invention to different inspection purposes, it is particularly advantageous if the light sources are displaceably supported or seated. This means that, by displacing the light sources, it then becomes possible to adapt the different light sources to different testing criteria.

In accordance with a preferred embodiment of the present invention, one light source has been arranged in such a way that the inspection light shines through the material to be inspected. Moreover, a second light source has been arranged in such a way that the respective inspection light from this second light source is reflected by the material to be inspected. As a result, it is possible to achieve, that by this arrangement, an incident light inspection, in which the inspection light is reflected by the material, can be performed simultaneously with a transmitted light inspection, in which the inspection light falls or passes through the material.

Only one sensor device is required for this combined incident light and transmitted light inspection. The incident light inspection is processed in a first color channel, while the transmitted light inspection is processed in a second color channel.

Alternatively, or in addition to this first preferred embodiment, it is also possible to arrange two light sources in such a way that the different colored inspection lights are both reflected, at different angles, by the material that is being inspected. With this second preferred embodiment, the input signals formed by the inspection light in the sensor device are processed in different color channels, so that different testing criteria can be recorded and processed with the use of only a single sensor device.

### BRIEF DESCRIPTION OF THE DRAWING

A preferred embodiment of the present invention is represented in the sole drawing FIGURE and will be described in greater detail in what follows.

The sole drawing FIGURE shows, in a schematic cross section, an arrangement for testing sheet-shaped material in accordance with the present invention.

### DESCRIPTION OF THE PREFERRED EMBODIMENT

The device for inspecting material, indicated generally at 01, in the sole drawing FIGURE includes a sensor device 02, which is embodied as a color line camera, three light sources 03, 04, 06, which together form an illumination device, and a support 07.

The material 08 to be inspected, which material may be, in particular, a sheet- or a web-shaped material 08, is introduced into the arrangement 01 by the use of suitable conveying arrangements, which are not specifically represented, and then lies flat on a top surface of the support 07. A recess or an aperture 09 is provided in the support 07, so that inspection light 12 emitted by a light source 06, which is arranged underneath the support 07, can fall into or be received in a lens of the sensor device 02. The first light source 03 emits inspection light 10 of the first monochrome light color red. The second light source 04 emits an inspection light 10 of the second monochrome light color blue. The third light source 6 emits the inspection light 12 of the third monochrome light color green. The sensor device 02 has three separate light channels for the light colors red, blue and green.

The process of the inspection of the image information, in particular the print image, of the material 08 is performed as follows. After the material 08 has been arranged above the recess or aperture 09, the three light sources 03, 04 and 06 simultaneously each emit their respective inspection light 10, 11 and 12 in the different light colors. The first, red inspection light 10 and the second, blue inspection light 11 are reflected at different angles at the surface of the sheet-shaped material 08 and together fall into or are received in the lens of the sensor device 02. As a result, it is thus possible to perform an angle-dependent incident light inspection of the sheet-shaped material 08. Simultaneously, the third, green inspection light 12 emitted by the third light source 06 falls or passes through the sheet-shaped material 08 and also into the lens of the sensor device 02. In this way, it is possible, simultaneously with the two incident light inspections accomplished by the first and second light colors red and blue, to perform a separate transmitted light inspection by use of the third light color green. The assignment of the three different light colors to the two different incident light and to the transmitted light inspections is basically arbitrary and can be interchanged.

The first, second and third inspection lights 10, 11 and 12 corresponding to the first, second and third different light colors red, blue and green, respectively, are processed in the sensor device 02 in separate color channels and are passed on to an evaluating device, which is not specifically represented. The image contents of each of the individual color channels can be processed separately from each other in the evaluation unit. However, it is, of course, also possible in accordance with the present invention to bring the input signals received on the separate color channels into correlation with each other in order to be able, for example, to draw spatial conclusions.

While a preferred embodiment of a device and method for inspecting material, in accordance with the present invention, has been set forth fully and completely hereinabove, it will be apparent to one of skill in the art that various changes in the specific image to be inspected, the specific structure of the support and the like could be made without departing from the true spirit and scope of the present invention which is to be limited only by the following claims.

What is claimed is:

1-13. (canceled)

14. A device for inspecting material comprising:
a sensor device;
an illumination device;
at least first and second light sources in said illumination device;
a first inspection light of a first color emitted by said first light source, and a second inspection light of a second color emitted by said second light source, said first and second colors being different;
at least first and second color channels in said sensor device, each of said at least first and second color channels being matched to said first and second inspection lights emitted from said first and second light sources, said at least first and second color channels receiving said first and second inspection lights that are at least one of passed through and reflected by the material; and
an evaluation device adapted to process image content of each of said at least first and second color channels.

15. The device of claim 14 wherein said at least first and second inspection lights emitted by said at least first and second light sources of said illumination device, after one of passing through and being reflected by the material, are recorded together by said sensor device and separately evaluated in said evaluation device.

16. The device of claim 14 wherein each of said at least first and second inspection lights are each a substantially monochrome light color.

17. The device of claim 14 wherein at least one of said spectral position and bandwidth of each said inspection light is matched to a transmission curve of said sensor device.

18. The device of claim 14 wherein said sensor device is a color line camera.

19. The device of claim 14 wherein said sensor device is a CCD camera.

20. The device of claim 14 wherein said sensor device has first, second and third color channels, wherein said illumination device has first, second and third light sources and wherein each first, second and third light sources emit first, second and third inspection lights matched to properties of said first, second and third color channels.

21. The device of claim 14 wherein said at least first and second light source are arranged at first and second different positions relative to the material.

22. The device of claim 21 wherein said at least first and second light sources are each displaceable.

23. The device of claim 14 wherein at least one of said at least first and second inspection lights passes through the material and another of said at least first and second inspection lights is reflected by the material.

24. The device of claim 14 wherein at least one of said at least first and second inspection lights is reflected by the material at a first angle and at least a second of said at least first and second inspection lights is reflected by the material at a second angle.

25. A method for inspecting material including:
providing a sensor device;
providing an illumination device;
providing at least first, second and third light sources in said illumination device;
directing first, second and third inspection lights from said first, second and third light sources, said first, second and third inspection lights having first, second and third differently colored lights;
providing at least first, second and third color channels in said sensor device and being matched to said first, second, and third inspection lights;
providing an evaluation unit for separately evaluating said first, second and third color channels;
reflecting a first one of said inspection lights, at a surface of the material, from said first light source to said first color channel of said sensor device;
reflecting a second one of said inspection lights, at a surface of the material, from said second light source to said second color channel of said sensor device;
passing a third one of said inspection lights through the material from said third light source to said third color channel of said sensor device; and
using said first and said second reflected inspection lights and said third passed through inspection light for simultaneously and separately performing two incident light inspections and one transmitted light inspection on said material.

26. The device of claim 14 wherein the material is a printed product including image information.

27. The method of claim 25 further including providing the material as a printed product including image information.
